(19) United States
(12) Patent Application Publication
(10) Pub. No.: US 2024/0188160 A1
(43) Pub. Date: Jun. 6, 2024

(54) DYNAMIC BANDWIDTH CAPACITY EXPANSION METHOD, APPARATUS AND SYSTEM

(71) Applicant: SPREADTRUM COMMUNICATIONS (SHANGHAI) CO., LTD., Shanghai (CN)

(72) Inventor: Jiawang YU, Shanghai (CN)

(21) Appl. No.: 18/286,452

(22) PCT Filed: Apr. 2, 2022
(86) PCT No.: PCT/CN2022/084975

§ 371 Date: Oct. 11, 2023

(30) Foreign Application Priority Data
Apr. 13, 2021 (CN) 202110396151.3

(51) Int. Cl. H04W 76/16; H04L 45/24; H04W 28/08; H04W 88/06

(52) U.S. Cl. CPC H04W 76/16; H04L 45/245; H04W 28/0925; H04W 88/06

(57) ABSTRACT

A dynamic bandwidth expansion method, apparatus and system are provided. The method may include: establishing a dynamic bandwidth expansion element, where the dynamic bandwidth expansion element includes at least two different network links; configuring an external interface for the dynamic bandwidth expansion element; and connecting with the external interface, and communicating with a server through the at least two different network links.

### CROSS-REFERENCE TO RELATED APPLICATIONS

This is the U.S. national stage of application No. PCT/CN2022/084975, filed on Apr. 2, 2022. Priority under 35 U.S.C. § 119(a) and 35 U.S.C. § 365(b) is claimed from Chinese Application No. 202110396151.3, filed Apr. 13, 2021, the disclosure of which is also incorporated herein by reference.

### TECHNICAL FIELD

The present disclosure generally relates to communication technology field, and more particularly, to a dynamic bandwidth expansion method, a dynamic bandwidth expansion apparatus and a dynamic bandwidth expansion system.

### BACKGROUND

Wireless Fidelity (WiFi), also known as wireless wideband, is a technology that allows electronic devices to connect to a Wireless Local Area Network (WLAN), which can improve interoperability between wireless network products based on the IEEE 802.11 standard. Wi-Fi has a high transmission speed but a small coverage suitable for smaller areas such as homes or offices. At present, Wi-Fi has become very popular, and cellular networks are also developing rapidly. Many users switch between wideband and data networks.

### SUMMARY

Embodiments of the present disclosure provide a dynamic bandwidth expansion method, a dynamic bandwidth expansion apparatus and a dynamic bandwidth expansion system, so as to provide users with larger bandwidth to meet users' need on bandwidth in large data volume application scenarios.

In an embodiment of the present disclosure, a dynamic bandwidth expansion method is provided, including establishing a dynamic bandwidth expansion element, where the dynamic bandwidth expansion element includes at least two different network links; configuring an external interface for the dynamic bandwidth expansion element: and connecting with the external interface, and communicating with a server through the at least two different network links.

In an embodiment of the present disclosure, a non-volatile or non-transitory storage medium having computer instructions stored therein is provided, where when the computer instructions are executed by a processor, the above method is performed.

In an embodiment of the present disclosure, an electronic device which includes a memory, and a processor is provided, where the memory has computer instructions stored therein, and when the processor executes the computer instructions, the above method is performed.

### BRIEF DESCRIPTION OF THE DRAWINGS

FIG. 1 is a flow chart of a dynamic bandwidth expansion method according to an embodiment.

FIG. 2 is a block diagram of a dynamic bandwidth expansion apparatus according to an embodiment.

FIG. 3 is a networking diagram of a dynamic bandwidth expansion system according to an embodiment.

### DETAILED DESCRIPTION

In order to clarify the objects, characteristics and advantages of the disclosure, embodiments of present disclosure will be described in detail in conjunction with accompanying drawings.

Among various factors that affect internet speed, the main one is actually effective bandwidth between any two devices. If network operators of two users belong to different companies, such as China Telecom, China Netcom or China Railcom, an actual network speed between them mainly depends on bandwidth of a backbone network between the two operators. The bandwidth of the backbone network is what is commonly referred to as actual bandwidth. Effective bandwidth refers to data that can be effectively transmitted per unit time on the actual bandwidth.

With continuous emergence of various applications, the demand for large bandwidth has become more prominent. At present, some terminal devices such as mobile phones can provide higher and more stable network services for some applications through multi-link aggregation technology.

Link aggregation refers to bringing together multiple physical ports to form a logical port to achieve load sharing of inbound and outbound traffic throughput on each member port. A switch determines which member port network packets are sent from based on a port load sharing policy configured by a user to a peer switch. Link aggregation is a technology used to increase link bandwidth and achieve link transmission resiliency and redundancy.

Multi-link aggregation is mainly aggregating a terminal device with a server device, or a proxy node based on Multi Path Transmission Control Protocol (MPTCP) and Multipath Quick UDP Internet Connections (MPQUIC) protocols. However, current aggregation technologies can only provide aggregation for applications on a single specific mobile phone but cannot meet a demand on large bandwidth of other devices such as PC, AR or VR. Therefore, embodiments of the present disclosure provide a dynamic bandwidth expansion method, apparatus, and system, which combines Wi-Fi multi-mode coexistence technology and multi-link aggregation technology to establish a dynamic bandwidth expansion element, and thus provides larger bandwidth for users without the multi-link aggregation function, thereby allowing users to acquire better user experience in large data volume application scenarios.

Referring to FIG. 1, FIG. 1 is a flow chart of a dynamic bandwidth expansion method according to an embodiment.

In 101, a dynamic bandwidth expansion element is established, where the dynamic bandwidth expansion element includes at least two different network links.

It should be noted that the at least two different network links may include but are not limited to 4G network links, 5G network links, Wi-Fi network links, etc., or may include other links that can be connected to a network, which is not limited in the embodiments of the present disclosure.

Specifically, the dynamic bandwidth expansion element may be established on a device with a multi-link aggregation function, such as a smartphone or a CPE.

The CPE is a mobile signal access device that receives mobile signals and forwards them as wireless Wi-Fi signals, is also a device that converts high-speed 4G or 5G signals into Wi-Fi signals and can support multiple mobile terminals to be connected with it to the Internet simultaneously.

A specific process of establishing the dynamic bandwidth expansion element on the device with the multi-link aggregation function includes connecting the device with the multi-link aggregation function to the network through the different network links and enabling aggregation and forwarding function of the device.

Taking a smartphone as an example, the process of establishing the dynamic bandwidth expansion element is as follows.

First, the smartphone is connected to a Wi-Fi network, and a data network switch of the smartphone is turned on, thereby establishing two different network links. Then, a network acceleration function of the smartphone is enabled.

The network acceleration function of the smartphone uses link aggregation technology to enable users to use WLAN and mobile data networks to access the Internet simultaneously. The method in the embodiment of the present disclosure mainly relies on this function in the smartphone but does not limit how to implement this function. For example, some existing technologies may be used to implement this function, which is not described in detail here.

In 102, an external interface is configured for the dynamic bandwidth expansion element.

The external interface refers to an interface that allows other devices to communicate with the dynamic bandwidth expansion element through the external interface. Specifically, it may be a virtual interface or a physical interface, which is not limited in the embodiments of the present disclosure. The device with the multi-link aggregation function is usually equipped with a corresponding wireless connection interface. Accordingly, it is merely necessary to enable the wireless connection interface.

Still taking the smartphone as an example, the external interface can be provided for other devices by enabling Wi-Fi hotspot or Bluetooth of the smartphone.

Wi-Fi hotspot is a technology that converts General Packet Radio Service (GPRS), 4G and 5G signals received by mobile phones into Wi-Fi signals and sends them out. The mobile phone serving as a hotspot should have a wireless Access Point (AP) function. Wi-Fi hotspot is a technology that allows electronic devices to connect to a WLAN, and generally uses 2.4G or 5G radio frequency bands.

Bluetooth is a radio technology that supports short-distance communication (generally within 10m) between devices, and enables wireless information exchange between devices including mobile phones, PDAs, wireless headsets, laptops, related peripherals, etc.

Further, other devices that need to use the dynamic bandwidth expansion element should also have corresponding WLAN access or Bluetooth interconnection functions.

In 103, the external interface is connected, and communication with a server is performed through the at least two different network links.

Based on configuration, the external interface can support access by multiple other devices simultaneously, provide link aggregation services for these devices, and meet the demand on large bandwidth of one or more service applications in these devices.

It should be noted that the multiple other devices may be a same type of devices or different types of devices, which is not limited in the embodiments of the present disclosure.

Taking a video conference software application on a terminal device (such as a computer) as an example, the dynamic bandwidth expansion method provided in the embodiments of the present disclosure is further described in detail below.

A smartphone is connected to a Wi-Fi network, a data network switch of the smartphone is turned on, a network acceleration function of the smartphone is enabled, and Wi-Fi hotspot of the smartphone is enabled.

After the above functions of the smartphone are configured, the video conference software on the terminal device is connected to a shared hotspot shared by the smartphone through Wi-Fi. Two sub-links including Wi-Fi and Cellular are generated on an AP side. Data on a server is aggregated and forwarded on the AP device to the terminal device based on the MPTCP or MPQUIC via Internet. The terminal device does not need to support the multi-link aggregation function and can use Wi-Fi and Cellular aggregation links simultaneously in a transparent manner.

With the dynamic bandwidth expansion method provided in the embodiments of the present disclosure, establishing a dynamic bandwidth expansion element including at least two different network links and configuring an external interface for the dynamic bandwidth expansion element enable other devices to connect with the external interface and communicate with a server through the at least two different network links provided by the dynamic bandwidth expansion element, thereby simply and conveniently meeting a need on large bandwidth of devices without the multi-link aggregation function. The embodiments of the present disclosure realize dynamic bandwidth expansion based on a multi-path transmission standard and fast data forwarding, provide link aggregation services for various types of devices, and meet the demand on large bandwidth of various services. Further, the solutions of the present disclosure also reduce single-link daily tariff of users. For example, originally, 100 Mbps wideband is required to meet a video conference demand of a user, while currently, 50 Mbps wideband plus a data network can meet the demand.

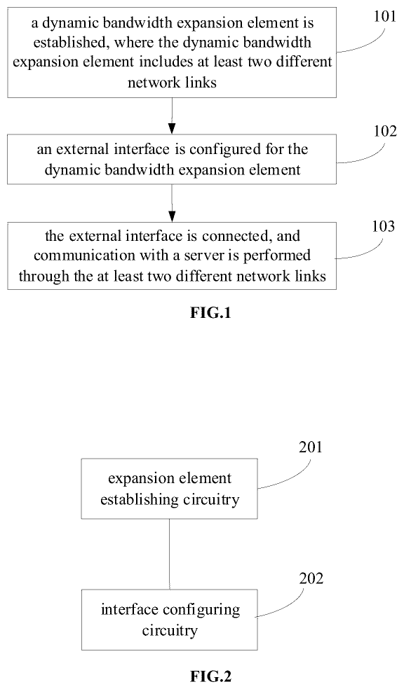

FIG. 2 is a block diagram of a dynamic bandwidth expansion apparatus according to an embodiment.

The dynamic bandwidth expansion apparatus includes: an expansion element establishing circuitry 201 configured to establish a dynamic bandwidth expansion element, where the dynamic bandwidth expansion element includes at least two different network links: and an interface configuring circuitry 202 configured to configure an external interface for the dynamic bandwidth expansion element.

The dynamic bandwidth expansion apparatus may be provided on a device with a multi-link aggregation function, such as a smartphone or a CPE.

The at least two different network links may include two or more selected from a group consisting of a 4G network link, a 5G network link, a Wi-Fi network link, etc., or may include other links that can be connected to a network, which is not limited in the embodiments of the present disclosure.

Accordingly, the expansion element establishing circuitry includes: a network connecting circuitry configured to connect the device with the multi-link aggregation function to a network through the at least two different network links respectively: and an aggregating circuitry configured to enable an aggregation and forwarding function of the device.

For example, taking a smartphone as an example, the network connecting circuitry connects the smartphone to the Wi-Fi network and turns on the data network switch of the smartphone, thus establishing two different network links. Then, the aggregating circuitry enables the network acceleration function of the smartphone.

The device with the multi-link aggregation function is usually provided with a corresponding wireless connection interface. Accordingly, the interface configuring circuitry may be specifically used to turn on the wireless connection interface of the device. For example, on a smartphone, the external interface can be provided for other devices by enabling Wi-Fi hotspot or Bluetooth of the smartphone.

With the dynamic bandwidth expansion apparatus provided in the embodiments of the present disclosure, establishing a dynamic bandwidth expansion element including at least two different network links and configuring an external interface for the dynamic bandwidth expansion element enable other devices to connect with the external interface and communicate with a server through the at least two different network links provided by the dynamic bandwidth expansion element, thereby simply and conveniently meeting a need on large bandwidth of devices without the multi-link aggregation function. The embodiments of the present disclosure realize dynamic bandwidth expansion based on a multi-path transmission standard and fast data forwarding, provide link aggregation services for various types of devices, and meet the need on large bandwidth of various services.

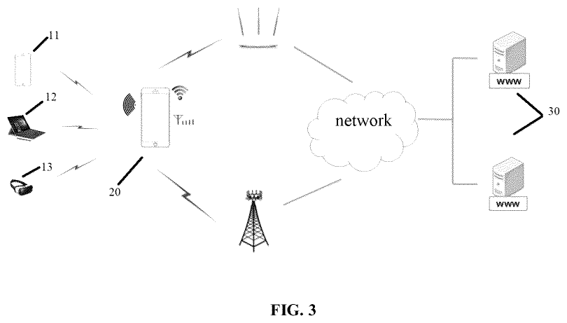

FIG. 3 is a networking diagram of a dynamic bandwidth expansion system according to an embodiment.

The dynamic bandwidth expansion system includes a terminal device that accesses a network through a dynamic bandwidth expansion apparatus and communicates with a server 30.

The terminal device may include any one or more of the following: computer, laptop, PAD, VR device, or AR device. FIG. 3 illustrates three different terminal devices including a mobile phone 11, a laptop 12 and a VR device 13.

The dynamic bandwidth expansion apparatus 20 is installed on the smartphone 20, accesses the Internet through Wi-Fi and GPRS links respectively, and provides a multi-link aggregation function for the terminal device.

Accordingly, the terminal device is connected to an external interface of the dynamic bandwidth expansion apparatus, and communicates with the server 30 in the Internet through at least two different network links provided by the dynamic bandwidth expansion apparatus.

In practice, APPs for various applications may be installed on the terminal device. The terminal device communicates with the server through the APPs to meet a demand on large bandwidth of the APPs' large traffic data applications.

In some embodiments, the above dynamic bandwidth expansion apparatus may correspond to a chip in a network device, such as a System-On-Chip (SOC), a baseband chip, or a chip module.

Each module/unit of each apparatus and product described in the above embodiments may be a software module/unit or a hardware module/unit or may be a software module/unit in part, and a hardware module/unit in part.

For example, for each apparatus or product applied to or integrated in a chip, each module/unit included therein may be implemented by hardware such as circuits; or, at least some modules/units may be implemented by a software program running on a processor integrated inside the chip, and the remaining (if any) part of the modules/units may be implemented by hardware such as circuits. For each apparatus or product applied to or integrated in a chip module, each module/unit included therein may be implemented by hardware such as circuits. Different modules/units may be disposed in a same component (such as a chip or a circuit module) or in different components of the chip module. Or at least some modules/units may be implemented by a software program running on a processor integrated inside the chip module, and the remaining (if any) part of the modules/units may be implemented by hardware such as circuits. For each apparatus or product applied to or integrated in a terminal, each module/unit included therein may be implemented by hardware such as circuits. Different modules/units may be disposed in a same component (such as a chip or a circuit module) or in different components of the terminal. Or at least some modules/units may be implemented by a software program running on a processor integrated inside the terminal, and the remaining (if any) part of the modules/units may be implemented by hardware such as circuits.

In an embodiment of the present disclosure, a non-volatile or non-transitory computer-readable storage medium having computer instructions stored therein is provided, where when the computer instructions are executed by a processor, the method as shown in FIG. 1 is performed.

In an embodiment of the present disclosure, a dynamic bandwidth expansion apparatus including a memory and a processor is provided, where when the computer instructions are executed by the processor, the method as shown in FIG. 1 is performed.

In an embodiment of the present disclosure, an electronic device including a memory and a processor is provided, where when the computer instructions are executed by the processor, the method as shown in FIG. 1 is performed.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A dynamic bandwidth expansion method, comprising:
establishing a dynamic bandwidth expansion element, wherein the dynamic bandwidth expansion element comprises at least two different network links;
configuring an external interface for the dynamic bandwidth expansion element; and
connecting with the external interface and communicating with a server through the at least two different network links.

2. The method according to claim 1, wherein said establishing the dynamic bandwidth expansion element comprises: establishing the dynamic bandwidth expansion element on a device with a multi-link aggregation function.

3. The method according to claim 2, wherein the device with the multi-link aggregation function comprises a smartphone or a Customer Premise Equipment (CPE); and
the at least two different network links comprise two or more selected from a group consisting of a 4G network link, a 5G network link, and a Wi-Fi network link.

4. The method according to claim 2, wherein said establishing the dynamic bandwidth expansion element on the device with the multi-link aggregation function comprises:
connecting the device with the multi-link aggregation function to a network through the at least two different network links respectively; and
enabling an aggregation and forwarding function of the device.

5. The method according to claim 2, wherein said configuring the external interface for the dynamic bandwidth expansion element comprises:
enabling a wireless connection interface of the device with the multi-link aggregation function.

6-13. (canceled)

14. A non-volatile or non-transitory computer-readable storage medium storing one or more programs, the one or more programs comprising computer instructions, which, when executed by a processor, cause the processor to:
establish a dynamic bandwidth expansion element, wherein the dynamic bandwidth expansion element comprises at least two different network links; and
configure an external interface for the dynamic bandwidth expansion element.

15. An electronic device, comprising a memory and a processor, wherein the memory stores one or more programs, the one or more programs comprising computer instructions, which, when executed by the processor, cause the processor to:
establish a dynamic bandwidth expansion element, wherein the dynamic bandwidth expansion element comprises at least two different network links; and
configure an external interface for the dynamic bandwidth expansion element.

16. The electronic device according to claim 15, wherein the processor is further caused to: establish the dynamic bandwidth expansion element on a device with a multi-link aggregation function.

17. The electronic device according to claim 16, wherein the device with the multi-link aggregation function comprises a smartphone or a Customer Premise Equipment (CPE); and
the at least two different network links comprise two or more selected from a group consisting of a 4G network link, a 5G network link, and a Wi-Fi network link.

18. The electronic device according to claim 16, wherein the processor is further caused to:
connect the device with the multi-link aggregation function to a network through the at least two different network links respectively; and
enable an aggregation and forwarding function of the device.

19. The electronic device according to claim 17, wherein the processor is further caused to:
connect the device with the multi-link aggregation function to a network through the at least two different network links respectively; and
enable an aggregation and forwarding function of the device.

20. The electronic device according to claim 16, wherein the processor is further caused to:
enable a wireless connection interface of the device with the multi-link aggregation function.

21. The electronic device according to claim 17, wherein the processor is further caused to:
enable a wireless connection interface of the device with the multi-link aggregation function.

22. The method according to claim 3, wherein said establishing the dynamic bandwidth expansion element on the device with the multi-link aggregation function comprises:
connecting the device with the multi-link aggregation function to a network through the at least two different network links respectively; and
enabling an aggregation and forwarding function of the device.

23. The method according to claim 3, wherein said configuring the external interface for the dynamic bandwidth expansion element comprises:
enabling a wireless connection interface of the device with the multi-link aggregation function.

24. The non-volatile or non-transitory computer-readable storage medium according to claim 14, wherein the processor is further caused to: establish the dynamic bandwidth expansion element on a device with a multi-link aggregation function.

25. The non-volatile or non-transitory computer-readable storage medium according to claim 24, wherein the device with the multi-link aggregation function comprises a smartphone or a Customer Premise Equipment (CPE); and
the at least two different network links comprise two or more selected from a group consisting of a 4G network link, a 5G network link, and a Wi-Fi network link.

26. The non-volatile or non-transitory computer-readable storage medium according to claim 24, wherein the processor is further caused to:
connect the device with the multi-link aggregation function to a network through the at least two different network links respectively; and
enable an aggregation and forwarding function of the device.

27. The non-volatile or non-transitory computer-readable storage medium according to claim 25, wherein the processor is further caused to:
connect the device with the multi-link aggregation function to a network through the at least two different network links respectively; and
enable an aggregation and forwarding function of the device.

28. The non-volatile or non-transitory computer-readable storage medium according to claim 24, wherein the processor is further caused to:
enable a wireless connection interface of the device with the multi-link aggregation function.
